(19) United States
(12) Patent Application Publication
(10) Pub. No.: US 2025/0374236 A1
(43) Pub. Date: Dec. 4, 2025

(54) Methods And Apparatus For Sensing Operation In Integrated Sensing And Communications System

(71) Applicant: MediaTek Singapore Pte. Ltd., Singapore (SG)

(72) Inventors: Wenze Qu, Beijing (CN); Jianwei Zhang, Beijing (CN); Min Lei, Beijing (CN); Xuanbo Shao, Beijing (CN); Haoran Li, Beijing (CN); Tao Chen, Beijing (CN)

(21) Appl. No.: 19/216,757

(22) Filed: May 23, 2025

(30) Foreign Application Priority Data
May 29, 2024 (WO) PCT/CN2024/096134
May 19, 2025 (CN) 202510646143.8

(51) Int. Cl. H04W 64/00; H04W 24/04

(52) U.S. Cl. CPC H04W 64/006; H04W 24/04

(57) ABSTRACT

Various solutions for sensing operation in integrated sensing and communications (ISAC) system are described. An apparatus, operating as a sensing node, may transmit a capability report to a sensing function (SF). The capability report indicates that the apparatus supports a sensing operation. The apparatus may receive a sensing task configuration from the SF. Then, the apparatus may perform the sensing operation based on the sensing task configuration. The sensing operation may involve receiving a downlink (DL) sensing signal according to the sensing task configuration, and/or transmitting an uplink (UL) sensing signal according to the sensing task configuration.

### CROSS REFERENCE TO RELATED PATENT APPLICATION(S)

The present disclosure is part of a non-provisional application claiming the priority benefit of PCT Application No. PCT/CN2024/096134, filed 29 May 2024, and CN application No. 202510646143.8, filed 19 May 2025. The contents of aforementioned applications are herein incorporated by reference in their entirety.

### TECHNICAL FIELD

The present disclosure is generally related to mobile communications and, more particularly, to sensing operation with respect to various operation modes (e.g., idle mode, inactive mode, and connected mode) in integrated sensing and communications (ISAC) system.

### BACKGROUND

Unless otherwise indicated herein, approaches described in this section are not prior art to the claims listed below and are not admitted as prior art by inclusion in this section.

Mobile communication and radar sensing have been advancing independently for decades. Until recently, the coexistence, cooperation, and joint design of the two systems become of interest. Motivation for such topic may include that the use of millimeter waves in 5^{th} generation (5G) and beyond leads to an occupation of adjacent frequency bands, which makes the convergence of the frequency bands used by two systems possible. In addition, with the increasing use of radar sensing in consumer devices and automotive applications, radar systems have entered mass markets. Given that jointly handling communications and sensing on the same architecture or platform would be more cost effective and have lower complexity as compared to two independent platforms, the concept of joint communication and sensing (or called ISAC) is introduced and the beyond 5G (B5G) or 6^{th} Generation (6G) system is envisioned to support sensing service within communication framework.

As the topic is still under study, the design of sensing service continuity for ISAC is not yet defined and it has become an important issue for newly developed wireless communication systems. Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to sensing operation in ISAC system. It is believed that the above-described issue would be avoided or otherwise alleviated by implementing one or more of the proposed schemes described herein.

In one aspect, a method may involve an apparatus, operating as a sensing node, transmitting a capability report to a sensing function (SF), wherein the capability report indicates that the apparatus supports a sensing operation. The method may further involve the apparatus receiving a sensing task configuration from the SF. The method may also involve the apparatus performing the sensing operation based on the sensing task configuration, wherein the sensing operation comprises at least one of the following: (i) receiving a downlink (DL) sensing signal according to the sensing task configuration; and (ii) transmitting an uplink (UL) sensing signal according to the sensing task configuration.

In one aspect, a method may involve an apparatus, operating as an SF, receiving a capability report from a sensing node, wherein the capability report indicates that the sensing node supports a sensing operation. The method may further involve the apparatus transmitting a sensing task configuration to the sensing node to enable the sensing node to perform the sensing operation based on the sensing task configuration, wherein the sensing operation comprises at least one of the following: (i) receiving a DL sensing signal according to the sensing task configuration; and (ii) transmitting an UL sensing signal according to the sensing task configuration.

In one aspect, an apparatus, operating as a sensing node, may comprise a transceiver which, during operation, wirelessly communicates with an SF. The apparatus may also comprise a processor communicatively coupled to the transceiver. The processor, during operation, may perform operations comprising transmitting, via the transceiver, a capability report to the SF, wherein the capability report indicates that the apparatus supports a sensing operation. The processor may also perform operations comprising receiving, via the transceiver, a sensing task configuration from the SF. The processor may further perform operations comprising performing the sensing operation based on the sensing task configuration, wherein the sensing operation comprises at least one of the following: (i) receiving, via the transceiver, a DL sensing signal according to the sensing task configuration; and (ii) transmitting, via the transceiver, an UL sensing signal according to the sensing task configuration.

It is noteworthy that, although description provided herein may be in the context of certain radio access technologies (RATs), networks and network topologies such as Long-Term Evolution (LTE), LTE-Advanced, LTE-Advanced Pro, 5G, New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting example sensing scenarios in accordance with the present disclosure.

FIG. 2 is a diagram depicting a communication environment in which various solutions and schemes in accordance with the present disclosure may be implemented.

FIG. 3 is a diagram depicting an example scenario of DL sensing in accordance with an implementation of the present disclosure.

FIG. 4 is a diagram depicting another example scenario of DL sensing in accordance with an implementation of the present disclosure.

FIG. 5 is a diagram depicting an example scenario of UL sensing in accordance with an implementation of the present disclosure.

FIG. 6 is a diagram depicting another example scenario of UL sensing in accordance with an implementation of the present disclosure.

FIG. 7 is a diagram depicting an example scenario of sensing assisted communication in accordance with an implementation of the present disclosure.

FIG. 8 is a diagram depicting an example scenario of discovery and triggering of idle-mode UE for sensing in accordance with an implementation of the present disclosure.

FIG. 9 is a diagram depicting an example scenario of sensing in CDRX in accordance with an implementation of the present disclosure.

FIG. 10 is a block diagram of an example communication system in accordance with an implementation of the present disclosure.

FIG. 11 is a flowchart of an example process in accordance with an implementation of the present disclosure.

FIG. 12 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to sensing operation in ISAC system. According to the present disclosure, a number of possible solutions may be implemented separately or jointly. That is, although these possible solutions may be described below separately, two or more of these possible solutions may be implemented in one combination or another.

The ISAC design is a critical feature for B5G/6G networks, which enables the widely deployed communication systems to be perceptive. In ISAC systems, sensing operation with respect to various operation modes, such as idle mode (e.g., RRC_IDLE mode), inactive mode (e.g., RRC_INACTIVE mode), and connected mode (e.g., RRC_CONNECTED mode), should be effectively and flexibly designed since sensing node's capability, mobility, and/or communication traffic requirement may change during the sensing tasks. For instance, in base station (BS)-user equipment (UE) bistatic sensing, the UE (i.e., the sensing node) may need to perform continuous and periodic sensing but at the same time, have very little communication data to transmit and/or receive (e.g., respiration detection is conducted at night, or intrusion detection is conducted when no one is at home). As such, if the UE keeps staying in the connected mode, there will be significant unnecessary power consumption, which is detrimental to UE power management. In addition, if sensing signals and communication signals are always configured to be separate signals, radio resource scheduling and management will become more complex for both the UE and the network.

In view of the above, the present disclosure proposes a number of schemes pertaining to sensing operation in ISAC system. According to the schemes of the present disclosure, procedures for sensing operation in ISAC are proposed, including (monostatic/bistatic) DL and UL sensing in idle/inactive mode, sensing assisted communication, discovery and triggering of idle-mode UE for sensing, and sensing in connected-mode discontinuous reception (CDRX). Accordingly, by applying the schemes of the present disclosure, the sensing node (e.g., UE or BS) may be allowed to receive sensing signal and make further processing to calculate sensing result in Idle/inactive mode, and if need, the sensing result may be reported to the SF after the sensing node enters connected mode, or the sensing result may be reported to the SF through small data transmission (SDT) (e.g., random access (RA)-SDT or configured grant (CG)-SDT) in inactive mode. Additionally, the sensing node may be allowed to transmit sensing signal to the SF through UL sensing signal in idle/inactive mode, or through SDT in inactive mode. Furthermore, the sensing node may be allowed to use DL sensing signal received in idle/inactive mode to assist communication procedures (e.g., radio resource management (RRM), synchronization (SYNC), and/or beam management (BM)) or to replace communication reference signal (RS) (e.g., synchronization signal block (SSB) or tracking reference signal (TRS)) to do RRM/SYNC/BM.

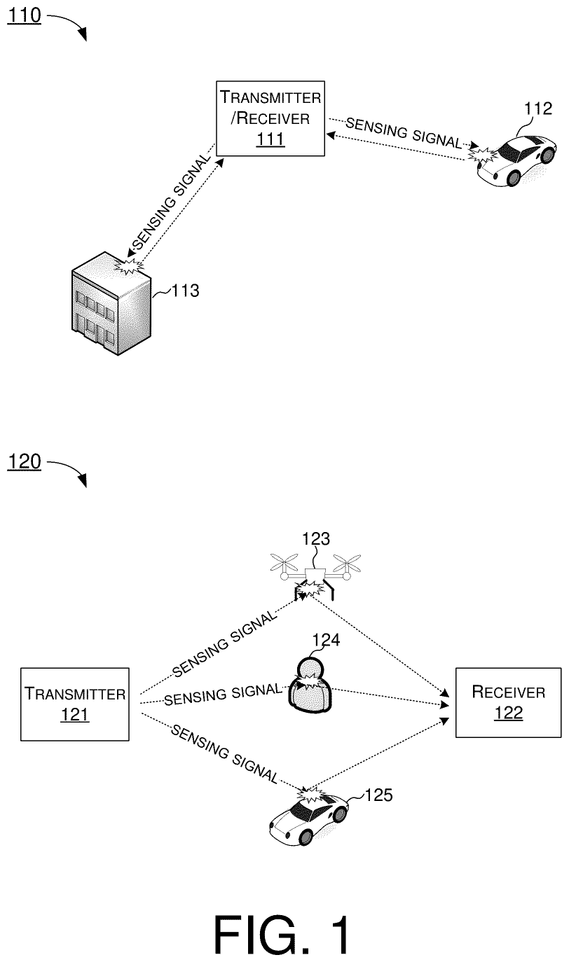

FIG. 1 illustrates example sensing scenarios 110 and 120 in accordance with the present disclosure. Scenario 110 involves a transmitter/receiver 111 and one or more targets 112 and 113, wherein the transmitter/receiver 111 is operating as a sensing node which supports monostatic sensing for any of the target 112 (e.g., a car) and the target 113 (e.g., a building). In monostatic sensing, the transmitter unit and receiver unit are generally co-located (e.g., within a single device) (or connected with fiber and act as a distributed monostatic system), and thus share complete knowledge of the transmitted signals and the clock. On the other hand, scenario 120 involves a transmitter 121, a receiver 122, and one or more targets 123 to 125, wherein the transmitter 121 and the receiver 122 are operating as a pair of sensing nodes (or a sensing node and an SF) which supports bistatic sensing for any of the target 123 (e.g., a UAV), the target 124 (e.g., a pedestrian), and the target 125 (e.g., a car). In bistatic sensing, the transmitter 121 and the receiver 122 are usually at different locations, where the receiver 122 may only have partial knowledge of the transmitted signals and certain synchronization (e.g., clock synchronization) between the transmitter 122 and the receiver 122 may be required. Each of the transmitter/receiver 111, the transmitter 121, and the receiver 122 may be a UE or a BS. In one example, the transmitter 121 may be a BS and the receiver 122 may be a UE, or the transmitter 121 may be a UE and the receiver 122 may be a BS. In another example, the transmitter 121 and the receiver 122 may be two BSs or two UEs. The UE may include a smartphone, a smartwatch, a personal digital assistant, a digital camera, a tablet computer, a laptop computer, a notebook computer, or an IoT/NB-IoT/IIoT apparatus. The BS may include an evolved NodeB (eNB) in 4G LTE, a next-generation NB (gNB) or a transmission and reception point (TRP) in 5G NR, or a B5G/6G NB.

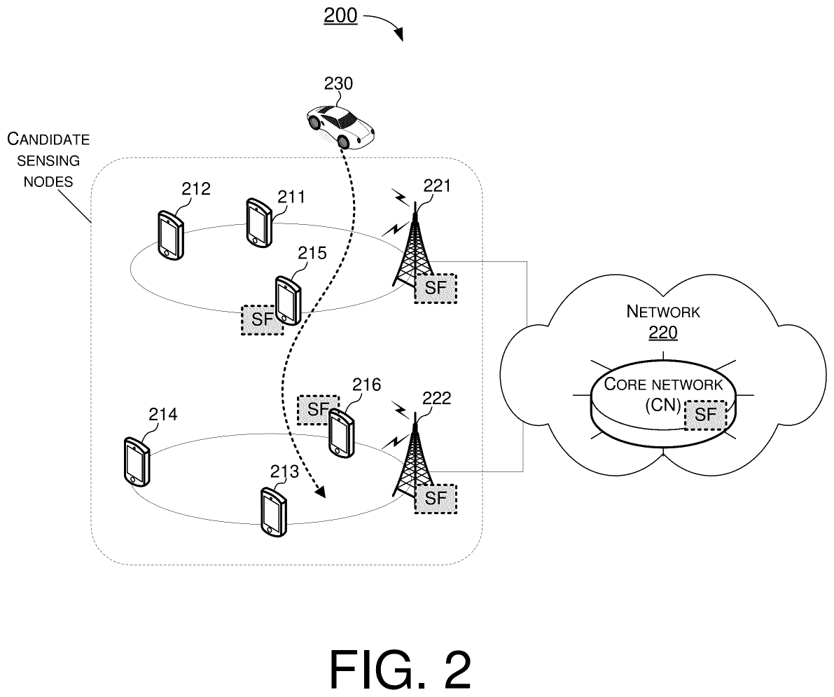

FIG. 2 illustrates an example scenario 200 of a communication environment in which various solutions and schemes in accordance with the present disclosure may be implemented. Scenario 200 involves a plurality of UEs 211-216 in wireless communication with a network 220 (e.g., a wireless network including a core network (CN)) via one or more BSs 221-222 (e.g., an eNB, a gNB, or a TRP), wherein the UEs 211-216 and the BSs 221-222 are candidate nodes which may be selected by an SF to operate as sensing nodes for sensing a target 230 (e.g., a car). As shown in FIG. 2, the SF may be a network node or a function deployed in the CN, in the BS 221/222, or in the UE 215/216, depending on the network architecture. The SF is responsible for the following: (i) building/generating and updating node list; (ii) configuring sensing task(s) for sensing nodes; (iii) controlling operation of node switching; (iv) suggesting (if SF is deployed in CN) or determining (if SF is deployed in UE or BS) sensing resources; and (v) collecting and integrating sensing results. The sensing nodes are responsible for the following: (i) transmitting and/or receiving sensing signal; (ii) processing sensing signal to obtain sensing result; and (iii) reporting sensing result to the SF. In such communication environment as shown in FIG. 2, the UEs 211-216, the BSs 221-222, and the network 220 may implement various schemes pertaining to sensing operation in ISAC system in accordance with the present disclosure, as described below. It is noteworthy that, while the various proposed schemes may be individually or separately described below, in actual implementations, some or all of the proposed schemes may be utilized or otherwise implemented jointly. Of course, each of the proposed schemes may be utilized or otherwise implemented individually or separately.

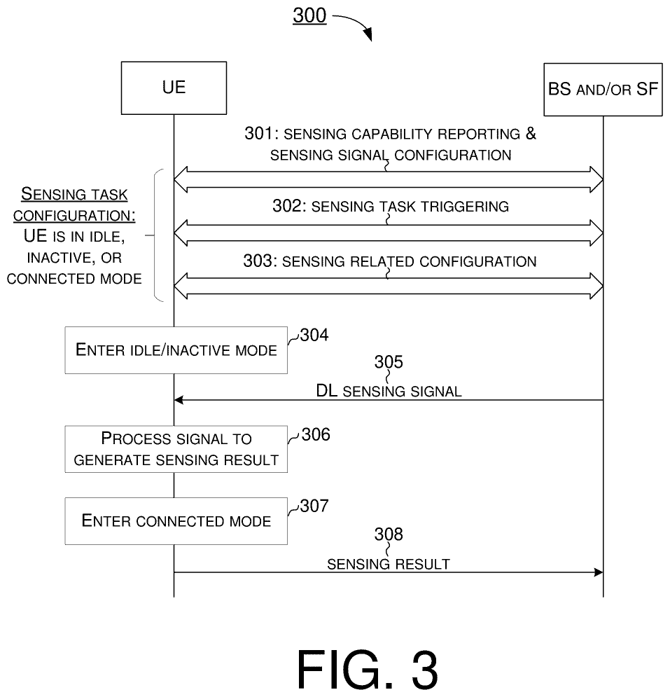

FIG. 3 illustrates an example scenario 300 of DL sensing in accordance with an implementation of the present disclosure. Scenario 300 depicts a BS-UE bistatic DL sensing scenario where the sensing task configuration may be performed in idle/inactive/connected mode, the DL sensing operation is performed in idle/inactive mode, and the sensing result reporting is performed in connected mode. In step 301, the UE may report its capability of supporting sensing operation, and receive configuration of sensing signal(s) (e.g., communication signal, such as SSB or TRS, or dedicated sensing signal) through system information block (SIB), radio resource control (RRC) signaling, medium access control-control element (MAC-CE), downlink control information (DCI), paging, or paging early indication (PEI), etc. The configuration may include the period, time and frequency domain pattern, bandwidth, and/or beam related information, etc., of sensing signal(s). Additionally or optionally, the sensing signal may be enabled or validated (e.g., effective time) through SIB, RRC signaling, MAC-CE, DCI, paging, or PEI, etc. The configuration and enabling/validation of sensing signal(s) may be performed in Idle/inactive/connected mode, before the BS and the UE start the sensing operation. In step 302, a sensing task (e.g., respiration detection or intrusion detection) is triggered by CN/BS/UE, which needs the UE to take part in this task. For example, the sensing task may require the UE to receive DL sensing signal, process the signal to generate sensing result, and report the sensing result to the BS/SF. In step 303, during the sensing-related configuration, the UE may be configured with at least one of the following: (i) first information indicating that the UE can perform DL sensing in the idle, inactive, and connected modes; (ii) second information of which signal(s) (e.g., SSB, TRS, or dedicated sensing signal) to be used in the sensing operation; and (iii) sensing measurement and reporting related information. The second information may also include enabling/validation and/or other additional configuration as part of the configuration that has been configured in step 301, or the sensing signal configuration and enabling/validation may be fully configured in step 303. The sensing measurement and reporting related information may include sensing task requirements (e.g., measurement quantities, quality requirement, periodicity, etc.), reporting requirements (e.g., what should be reported, including reporting quantities, reporting value format, reporting periodicity and type (periodic, aperiodic, or semi-persistent, etc.)), and an indication that the UE should enter connected mode to report the sensing result (if available). It should be noted that steps 301-303 may be performed in the order shown in FIG. 3 or, alternatively, in a different order; or steps 301-303 may be incorporated into a single step or fewer steps.

Next, in step 304, UE may enter idle/inactive mode when there is no need for communication data transmission and/or reception. In step 305, the UE may receive DL sensing signal in idle/inactive mode according to the configurations received in steps 301-303. In step 306, the UE may process the sensing signal to generate/obtain sensing result (e.g., using 2D-FFT/music algorithm to estimate target's delay/doppler/angle information, or calculating the signal's micro-doppler characteristics to get target's respiration rate). Then, in step 307, the UE may enter connected mode if it needs to report the sensing result. In step 308, the UE may report the sensing result to the BS/SF in connected mode. The reporting may be performed based on the configuration and requirement received in step 303. Alternatively, if the UE only needs to locally report the sensing result to the higher layer of UE (e.g., sensing APP in UE) (which means the UE does not need to report the sensing result to the BS/SF), then the UE may not enter connected mode (i.e., the UE may stay in idle/inactive mode to save power).

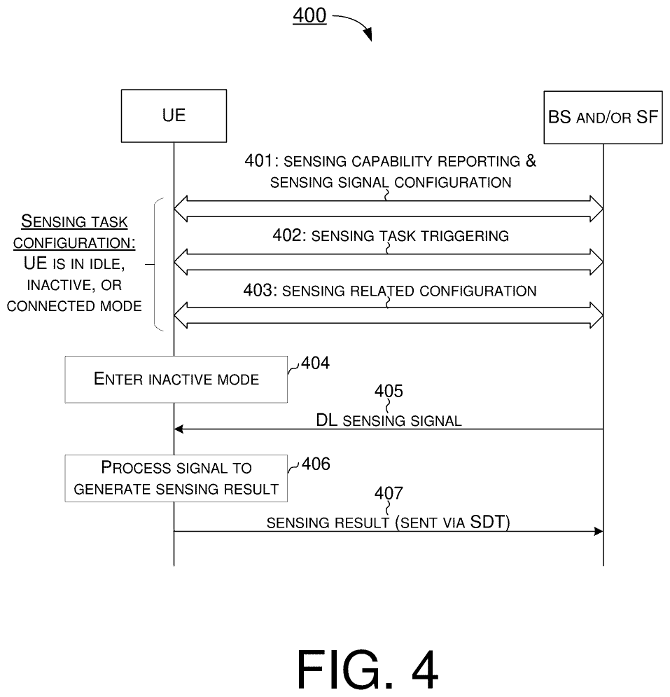

FIG. 4 illustrates an example scenario 400 of DL sensing in accordance with an implementation of the present disclosure. Scenario 400 depicts a BS-UE bistatic DL sensing scenario where the sensing task configuration may be performed in idle/inactive/connected mode, the DL sensing operation is performed in inactive mode, and the sensing result reporting is performed via SDT in inactive mode. The UE operation and BS/SF operation in steps 401-403 are similar to those in steps 301-303, except that in step 403, SDT related configuration is also configured to the UE, along with the configuration indicating that if the UE needs to report sensing result to BS/SF, it can report through RA-SDT or CG-SDT in inactive mode. Next, in step 404, UE may enter inactive mode when there is no need for communication data transmission and/or reception. In step 405, the UE may receive DL sensing signal in inactive mode according to the configurations received in steps 401-403. In step 406, the UE in inactive mode may process the sensing signal to generate/obtain sensing result (e.g., using 2D-FFT/music algorithm to estimate target's delay/doppler/angle information, or calculating the signal's micro-doppler characteristics to get target's respiration rate). Then, in step 407, the UE may report the sensing result to the BS/SF via RA-SDT or CG-SDT in inactive mode. The reporting may be performed based on the configuration and requirement received in step 403. Alternatively, if the UE only needs to locally report the sensing result to the higher layer of UE (e.g., sensing APP in UE), then the UE may not report the sensing result to the BS/SF. The UE may determine whether to select RA-SDT or CG-SDT for reporting, based on the SDT related configuration received in step 403 and the reporting data type (e.g., size, period, etc.). For example, RA-SDT may be used for event-trigger reporting, and CG-SDT may be used for periodic reporting. If the sensing result is not suitable to be reported through SDT (e.g., when the reporting data size is large), the UE may need to enter connected mode to report the sensing result.

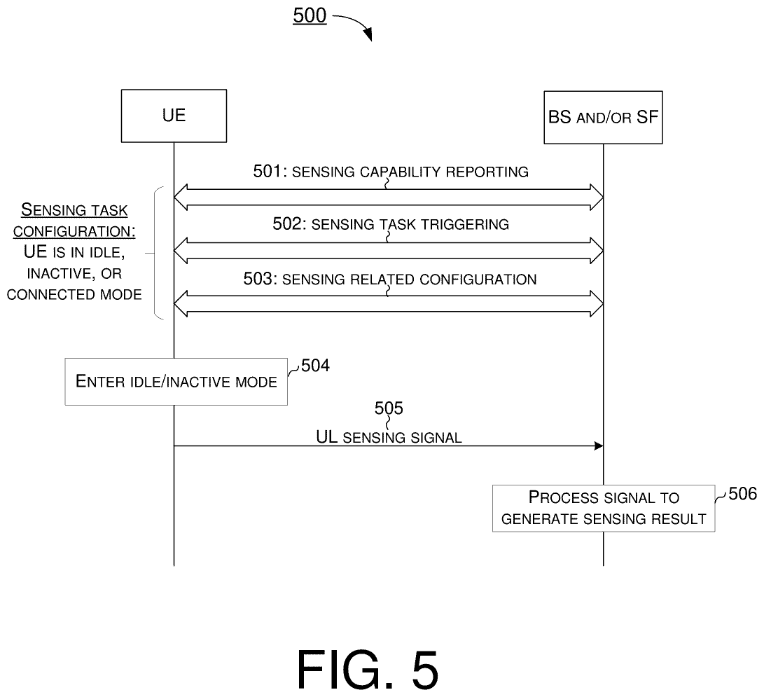

FIG. 5 illustrates an example scenario 500 of UL sensing in accordance with an implementation of the present disclosure. Scenario 500 depicts a BS-UE bistatic UL sensing scenario where the sensing task configuration may be performed in idle/inactive/connected mode and the UL sensing signal transmission is performed in idle/inactive mode (e.g., similar as UL positioning sounding reference signal (SRS)). In step 501, the UE may report its capability of supporting sensing operation (e.g., sensing signal transmission) to the BS/SF in idle/inactive/connected mode. In step 502, a sensing task (e.g., respiration detection, intrusion detection, UAV detection, or sensing environment around UE, etc.) that needs the UE to take part in this task is triggered by CN/BS/UE when the UE is in idle/inactive/connected mode. For example, the sensing task may require the UE to operate as a transmitter sensing node to transmit UL sensing signal to the BS/SF. In step 503, during the sensing-related configuration, the UE may be configured with at least one of the following: (i) information indicating that the UE can perform UL sensing in the idle, inactive, and connected modes (i.e., the UE is allowed to transmit UL sensing signal in idle/inactive mode.); and (ii) information of UL sensing signal(s) (e.g., UL SRS or dedicated UL sensing signal) to be used in the UL sensing operation. The UL sensing signal(s) may be configured and indicated through RRC signaling, MAC-CE, or uplink control information (UCI), etc. The configuration may include the period, time and frequency domain pattern, bandwidth, and/or beam related information, etc., of the UL sensing signal(s). The UL sensing signal(s) may be configured to be transmitted aperiodically, periodically, or semi-persistent.

Next, in step 504, UE may enter idle/inactive mode when there is no need for communication data transmission and/or reception. In step 505, the UE may transmit UL sensing signal in idle/inactive mode according to the configurations received in step 503. Then, in step 506, the BS/SF may process the sensing signal to generate/obtain sensing result (e.g., using 2D-FFT/music algorithm to estimate target's delay/Doppler/angle information, or calculating the signal's micro-doppler characteristics to get target's respiration rate). Alternatively, in another example, if the UE needs to enter connected mode for communication traffic, the UL sensing operation may be performed in connected mode and follow the configurations of sensing of connected mode.

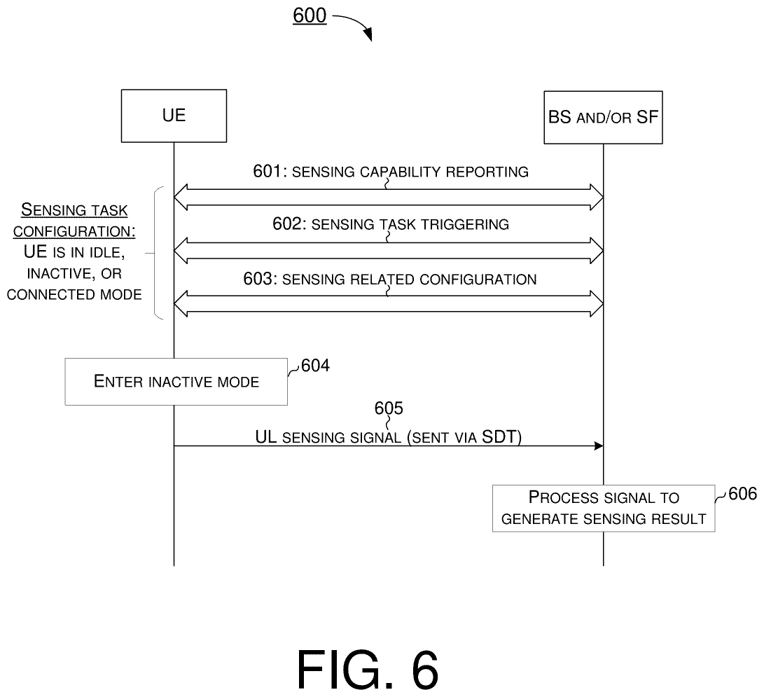

FIG. 6 illustrates an example scenario 600 of UL sensing in accordance with an implementation of the present disclosure. Scenario 600 depicts a BS-UE bistatic UL sensing scenario where the sensing task configuration may be performed in idle/inactive/connected mode and the UL sensing signal transmission is performed via SDT in inactive mode. The UE operation and BS/SF operation in steps 601-603 are similar to those in steps 501-503, except that in step 603, SDT related configuration is also configured to the UE, along with the configuration indicating the UE to perform UL sensing in inactive mode (e.g., to transmit UL sensing signal through RA-SDT/CG-SDT in inactive mode). Next, in step 604, UE may enter inactive mode when there is no need for communication data transmission and/or reception. In step 605, the UE may transmit UL sensing signal via RA-SDT or CG-SDT in inactive mode according to the configurations received in step 603. For example, if UL sensing signal is suitable to be transmitted through SDT, the UE may select either RA-SDT or CG-SDT for UL sensing signal transmission, depending on the type of sensing signal and SDT configuration received in step 603. In one example, if the UL sensing signal is short, periodic, and of small data size, the UE may use CG-SDT for the UL sensing signal transmission, or otherwise, use RA-SDT for event-trigger transmission. If UL sensing signal is not suitable to be transmitted through SDT (e.g., sensing signal resource is large) (which means UL sensing signal cannot be transmitted in inactive mode), the UE may need to enter connected mode for UL sensing signal transmission. Then, in step 606, the BS/SF may process the sensing signal to generate/obtain the sensing result.

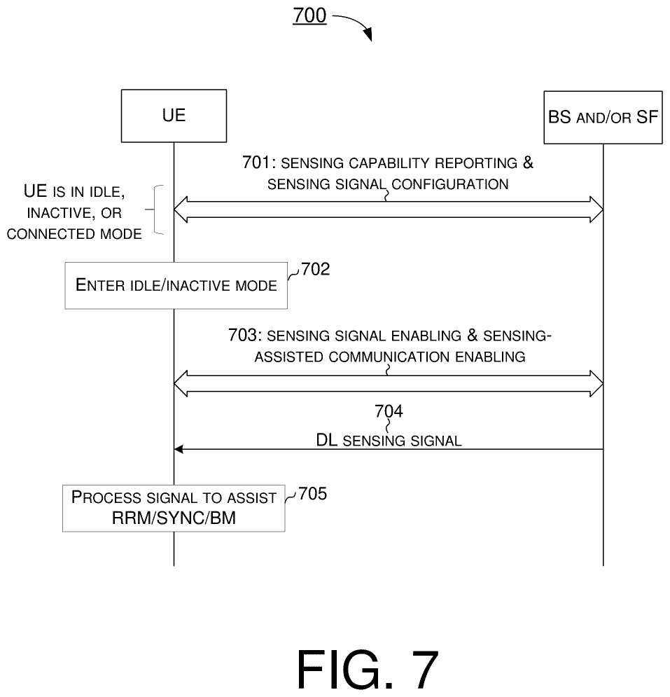

FIG. 7 illustrates an example scenario 700 of sensing assisted communication in accordance with an implementation of the present disclosure. Scenario 700 depicts a BS-UE bistatic UL sensing scenario where sensing capability reporting and sensing signal configuration may be performed in idle/inactive/connected mode and DL sensing signal reception is performed to assist communication procedure (e.g.,) in idle/inactive mode. In step 701, the UE may report its capability of supporting sensing operation and receive configuration of sensing signal(s) in idle/inactive/connected mode, similar to step 301. In step 702, the UE may enter idle or inactive mode when there is no need for communication data transmission and/or reception. In step 703, an indication or configuration for enabling/validating sensing signal may be received from the BS/SF, and the feature of sensing assisted communication may be enabled by BS/SF/UE. The indication/configuration of enabling/validation of sensing signal(s) may also include other additional configurations as part of the configuration that has been configured in step 701, or the sensing signal configuration and enabling/validation may be fully configured in step 701 or 703. The feature of sensing assisted communication may be enabled by the BS configuring the UE to use DL sensing signal to get some channel information and assist with communication procedure(s), such as RRM, SYNC, and/or BM. In one example, the UE may use DL sensing signal to replace certain communication RS(s) (e.g., SSB, and/or TRS, etc.) to perform RRM, SYNC, and/or BM. In step 704, the UE may receive DL sensing signal in idle/inactive mode according to the configurations received in steps 701 and 703. In step 705, the UE in idle/inactive mode may process the sensing signal to assist with communication procedure(s), such as RRM, SYNC, and/or BM. Additionally or optionally, the UE may not need to receive other communication RSs that were dedicated used for RRM, SYNC, and/or BM.

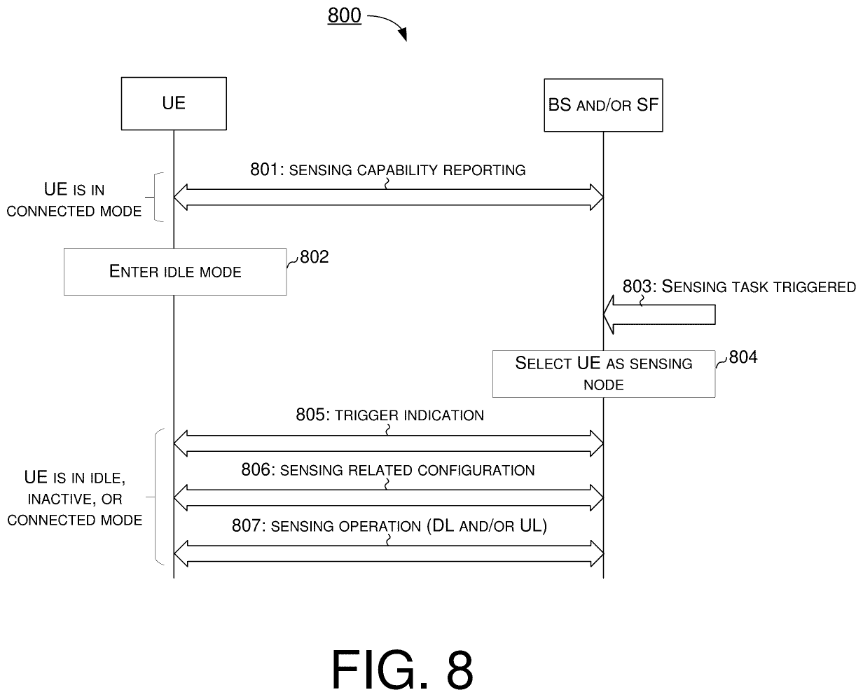

FIG. 8 illustrates an example scenario 800 of discovery and triggering of idle-mode UE for sensing in accordance with an implementation of the present disclosure. Scenario 800 depicts a BS-UE bistatic UL sensing scenario where the UE enters idle mode after sensing capability reporting and the BS/SF may discover and trigger the UE in idle mode to perform sensing as required by the triggered sensing task. In step 801, the UE may report its capability of supporting sensing operation and its position information to the BS/SF before entering idle mode. For example, the UE may report its sensing capability and that it is ready to operate as a sensing node (i.e., it can be candidate sensing node if there is sensing task) (e.g., UE can ensure that it will keep stationary in idle mode and always in the coverage of current cell), and the reporting may be performed during the RRC release stage. In step 802, the UE may enter idle mode, e.g., when RRC release is completed. In step 803, a sensing task is triggered in the network side. In step 804, the BS/SF may select the idle-mode UE as sensing node. In step 805, the BS/SF may transmit a trigger indication (e.g., through paging) to trigger the UE to enter connected mode (or idle/inactive mode). Next, in step 806, the BS/SF may configure the UE with sensing related configuration (e.g., configurations of sensing signal, sensing task, and others). In step 807, the UE and the BS/SF may start performing the sensing operation in idle/inactive/connected mode as indicated in the trigger indication received in step 805.

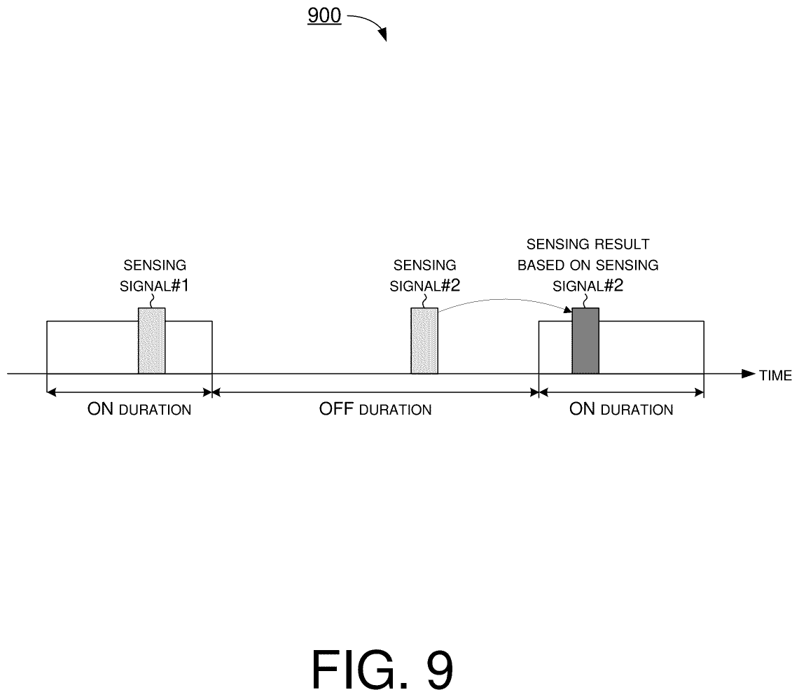

FIG. 9 illustrates an example scenario 900 of sensing in CDRX in accordance with an implementation of the present disclosure. Scenario 900 depicts the case of sensing operation being performed in CDRX of RRC connected mode as a way to improve UE power saving. As shown in FIG. 9, network (e.g., BS and/or SF) may configure the UE to transmit UL sensing signal or receive DL sensing signal (denoted as sensing signal #1) during CDRX on-duration, and/or configure the UE to receive DL sensing signal (denoted as sensing signal #2) during CDRX off-duration. Additionally, the UE may need to make further signal processing on the DL sensing signal received in off-duration to generate sensing result. The sensing result reporting may follow the rule of communication UL data transmission in CDRX. For example, the sensing result may be reported in a next CDRX on-duration.

It should be noted that the proposed schemes of the present disclosure are not limited to applying only in a bistatic sensing scenario (e.g., the depicted scenarios in FIGS. 3-9) and can also apply in a monostatic sensing scenario as well.

### Illustrative Implementations

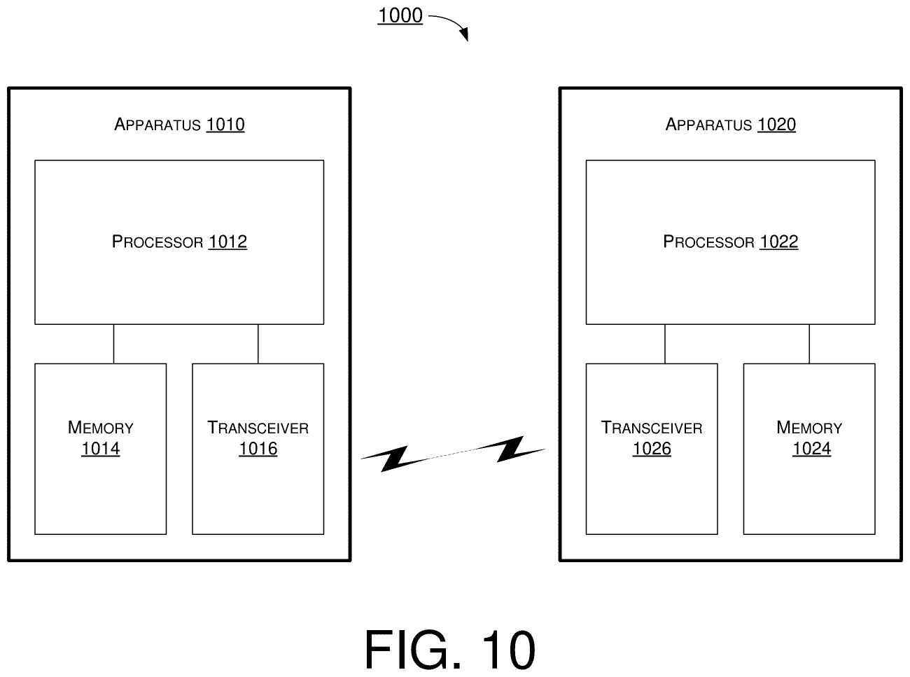

FIG. 10 illustrates an example communication system 1000 having two example apparatuses 1010 and 1020 in accordance with an implementation of the present disclosure. Each of apparatus 1010 and apparatus 1020 may perform various functions to implement schemes, techniques, processes and methods described herein pertaining to sensing operation in ISAC system, including scenarios/schemes described above as well as processes 1100 and 1200 described below.

Apparatus 1010 may be a part of an electronic apparatus operating as sensing node, which may be a UE or BS with sensing capability. The UE may be a portable or mobile apparatus, a wearable apparatus, a wireless communication apparatus or a computing apparatus (e.g., mounted on vehicles). For instance, apparatus 1010 may be implemented in a smartphone, a smartwatch, a personal digital assistant, a digital camera, or a computing equipment such as a tablet computer, a laptop computer or a notebook computer. The UE may also be a part of a machine type apparatus, which may be an IoT, NB-IoT, or IIoT apparatus such as an immobile or a stationary apparatus, a home apparatus, a wire communication apparatus or a computing apparatus. For instance, apparatus 1010 may be implemented in a smart thermostat, a smart fridge, a smart door lock, a wireless speaker or a home control center. Alternatively, apparatus 1010 may be a network node such as a BS, a small cell, a router or a gateway. For instance, apparatus 1010 may be implemented in an eNB in an LTE, LTE-Advanced or LTE-Advanced Pro network or in a gNB in a 5G, NR, IoT, NB-IoT or IIoT network. Furthermore, apparatus 1010 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Apparatus 1010 may include at least some of those components shown in FIG. 10 such as a processor 1012, for example. Apparatus 1010 may further include one or more other components not pertinent to the proposed scheme of the present disclosure (e.g., internal power supply, display device and/or user interface device), and, thus, such component(s) of apparatus 1010 are neither shown in FIG. 10 nor described below in the interest of simplicity and brevity.

Apparatus 1020 may be a part of an electronic apparatus operating as an SF, which may be implemented in a UE, a BS, or a network node in the CN of a wireless network. Furthermore, apparatus 1020 may be implemented in the form of one or more IC chips such as, for example and without limitation, one or more single-core processors, one or more multi-core processors, one or more RISC processors, or one or more CISC processors. Apparatus 1020 may include at least some of those components shown in FIG. 10 such as a processor 1022, for example. Apparatus 1020 may further include one or more other components not pertinent to the proposed scheme of the present disclosure (e.g., internal power supply, display device and/or user interface device), and, thus, such component(s) of apparatus 1020 are neither shown in FIG. 10 nor described below in the interest of simplicity and brevity.

In one aspect, each of processor 1012 and processor 1022 may be implemented in the form of one or more single-core processors, one or more multi-core processors, or one or more CISC processors. That is, even though a singular term “a processor” is used herein to refer to processor 1012 and processor 1022, each of processor 1012 and processor 1022 may include multiple processors in some implementations and a single processor in other implementations in accordance with the present disclosure. In another aspect, each of processor 1012 and processor 1022 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1012 and processor 1022 is a special-purpose machine specifically designed, arranged and configured to perform specific tasks including the sensing operation in ISAC system in accordance with various implementations of the present disclosure.

In some implementations, apparatus 1010 may also include a transceiver 1016 coupled to processor 1012 and capable of wirelessly transmitting and receiving communication and sensing signals. In some implementations, transceiver 1016 may be capable of wirelessly communicating with different types of UEs/BSs of different RATs. In some implementations, transceiver 1016 may be equipped with a plurality of antenna ports (not shown) such as, for example, four antenna ports. That is, transceiver 1016 may be equipped with multiple transmit antennas and multiple receive antennas for multiple-input multiple-output (MIMO) wireless communications. In some implementations, apparatus 1020 may also include a transceiver 1026 coupled to processor 1022 and capable of communicating with and coordinating sensing nodes such as UEs and BSs. In some implementations, transceiver 1026 may be equipped with a plurality of antenna ports (not shown) such as, for example, four antenna ports. That is, transceiver 1026 may be equipped with multiple transmit antennas and multiple receive antennas for MIMO wireless communications. In some implementations, transceiver 1026 may be equipped with a wired network interface such as fiber optic cable for communicating with other network nodes. Accordingly, apparatus 1010 and apparatus 1020 may communicate with each other directly or indirectly (depending on the network architecture) via transceiver 1016 and transceiver 1026, respectively.

In some implementations, apparatus 1010 may further include a memory 1014 coupled to processor 1012 and capable of being accessed by processor 1012 and storing data therein. In some implementations, apparatus 1020 may further include a memory 1024 coupled to processor 1022 and capable of being accessed by processor 1022 and storing data therein. Each of memory 1014 and memory 1024 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1014 and memory 1024 may include a type of read-only memory (ROM) such as mask ROM, programmable ROM (PROM), erasable programmable ROM (EPROM) and/or electrically erasable programmable ROM (EEPROM). Alternatively, or additionally, each of memory 1014 and memory 1024 may include a type of non-volatile random-access memory (NVRAM) such as flash memory, solid-state memory, ferroelectric RAM (FeRAM), magnetoresistive RAM (MRAM) and/or phase-change memory.

Each of apparatus 1010 and apparatus 1020 may be a communication entity capable of communicating with each other using various proposed schemes in accordance with the present disclosure. For illustrative purposes and without limitation, a description of operations, functionalities, and capabilities of apparatus 1010, implemented in or operating as a sensing node, and apparatus 1020, implemented in or operating as an SF, is provided below with processes 1100 and 1200.

### Illustrative Processes

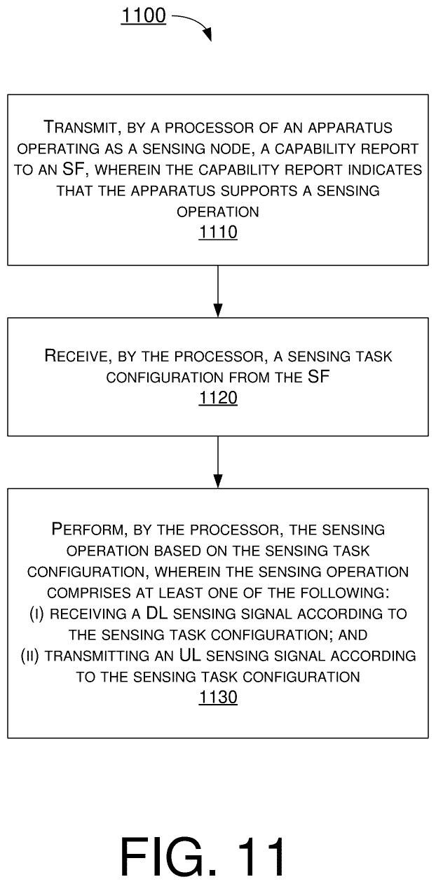

FIG. 11 illustrates an example process 1100 in accordance with an implementation of the present disclosure. Process 1100 may be an example implementation of above scenarios/schemes, whether partially or completely, with respect to sensing operation in ISAC system. Process 1100 may represent an aspect of implementation of features of apparatus 1010, implemented in or operating as a sensing node. Process 1100 may include one or more operations, actions, or functions as illustrated by one or more of blocks 1110 to 1130. Although illustrated as discrete blocks, various blocks of process 1100 may be divided into additional blocks, combined into fewer blocks, or eliminated, depending on the desired implementation. Moreover, the blocks of process 1100 may be executed in the order shown in FIG. 11 or, alternatively, in a different order. Process 1100 may be implemented by apparatus 1010 or any suitable UE/BS or machine type device with sensing capability. Solely for illustrative purposes and without limitation, process 1100 is described below in the context of apparatus 1010, operating as a sensing node, and apparatus 1020, operating as an SF. Process 1100 may begin at block 1110.

At block 1110, process 1100 may involve processor 1012 of apparatus 1010, transmitting, via transceiver 1016, a capability report to apparatus 1020, wherein the capability report indicates that apparatus 1010 supports a sensing operation. Process 1100 may proceed from block 1110 to block 1120.

At block 1120, process 1100 may involve processor 1012 receiving, via transceiver 1016, a sensing task configuration from apparatus 1020. Process 1100 may proceed from block 1120 to block 1130.

At block 1130, process 1100 may involve processor 1012 performing the sensing operation based on the sensing task configuration, wherein the sensing operation comprises at least one of the following: (i) receiving, via transceiver 1016, a DL sensing signal according to the sensing task configuration; and (ii) transmitting, via transceiver 1016, an UL sensing signal according to the sensing task configuration.

In some implementations, the sensing operation may further comprise performing sensing of a target object based on the DL sensing signal to generate a sensing result.

In some implementations, the DL sensing signal may be received in an idle mode or an inactive mode, and the sensing operation may further comprise entering a connected mode to transmit the sensing result to apparatus 1020.

In some implementations, the DL sensing signal may be received in an inactive mode, and the sensing operation may further comprise staying in the inactive mode to transmit the sensing result to apparatus 1020 via an SDT.

In some implementations, the UL sensing signal may be transmitted in an idle mode or an inactive mode, or the UL sensing signal may be transmitted via an SDT in the inactive mode.

In some implementations, process 1100 may further involve processor 1012 performing an RRM, a synchronization, or a BM based on the DL sensing signal.

In some implementations, process 1100 may further involve processor 1012 receiving, via transceiver 1016, an indication from apparatus 1020 in an idle mode, and entering the idle mode, an inactive mode, or a connected mode to perform the sensing operation responsive to the indication.

In some implementations, the DL sensing signal or the UL sensing signal may be received or transmitted in a CDRX ON duration, or the DL sensing signal may be received in a CDRX OFF duration and a sensing result corresponding to the DL sensing signal may be transmitted in a next CDRX ON duration.

In some implementations, the DL sensing signal may include an SSB, a TRS, or a dedicated DL sensing signal, and the UL sensing signal may include an SRS or a dedicated UL sensing signal.

In some implementations, apparatus 1020 may include a BS, a CN node, or a UE.

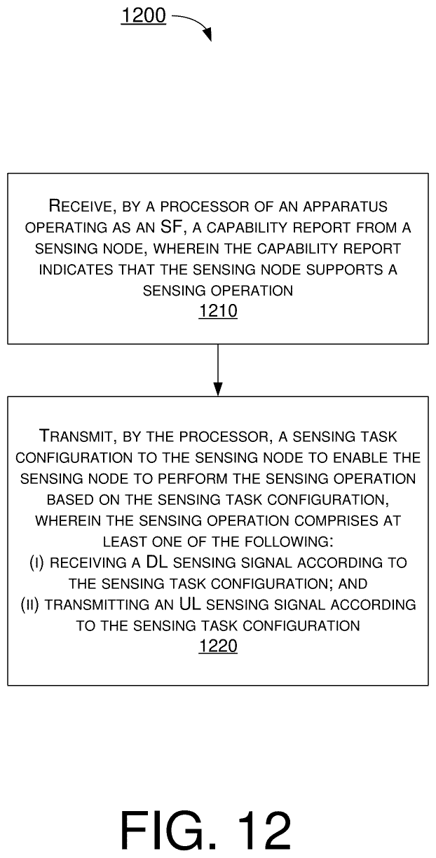

FIG. 12 illustrates an example process 1200 in accordance with an implementation of the present disclosure. Process 1200 may be an example implementation of above scenarios/schemes, whether partially or completely, with respect to sensing operation in ISAC system. Process 1200 may represent an aspect of implementation of features of apparatus 1020. Process 1200 may include one or more operations, actions, or functions as illustrated by one or more of blocks 1210 to 1220. Although illustrated as discrete blocks, various blocks of process 1200 may be divided into additional blocks, combined into fewer blocks, or eliminated, depending on the desired implementation. Moreover, the blocks of process 1200 may be executed in the order shown in FIG. 12 or, alternatively, in a different order. Process 1200 may be implemented by apparatus 1020 or any suitable UE or network node capable of operating as an SF. Solely for illustrative purposes and without limitation, process 1200 is described below in the context of apparatus 1010, operating as a sensing node, and apparatus 1020, operating as an SF. Process 1200 may begin at block 1210.

At block 1210, process 1200 may involve processor 1022 of apparatus 1020, receiving, via transceiver 1026, a capability report from apparatus 1010, wherein the capability report indicates that apparatus 1010 supports a sensing operation. Process 1200 may proceed from block 1210 to block 1220.

At block 1220, process 1200 may involve processor 1022 transmitting, via transceiver 1026, a sensing task configuration to apparatus 1010 to enable the sensing node to perform the sensing operation based on the sensing task configuration, wherein the sensing operation comprises at least one of the following: (i) receiving a DL sensing signal according to the sensing task configuration; and (ii) transmitting an UL sensing signal according to the sensing task configuration.

In some implementations, the sensing operation may further comprise performing sensing of a target object based on the DL sensing signal to generate a sensing result.

In some implementations, the DL sensing signal may be received in an idle mode or an inactive mode, and the sensing operation may further comprise entering a connected mode to transmit the sensing result to apparatus 1020.

In some implementations, the DL sensing signal may be received in an inactive mode, and the sensing operation may further comprise staying in the inactive mode to transmit the sensing result to apparatus 1020 via an SDT.

In some implementations, the UL sensing signal may be transmitted in an idle mode or an inactive mode, or the UL sensing signal may be transmitted via an SDT in the inactive mode.

In some implementations, process 1200 may further involve processor 1022 transmitting, via transceiver 1026, an indication to apparatus 1010, wherein the indication indicates apparatus 1010 to perform an RRM, a synchronization, or a BM based on the DL sensing signal.

In some implementations, process 1200 may further involve processor 1022 transmitting, via transceiver 1026, an indication to apparatus 1010, wherein the indication triggers apparatus 1010 to enter an idle mode, an inactive mode, or a connected mode to perform the sensing operation.

In some implementations, the DL sensing signal or the UL sensing signal may be received or transmitted in a CDRX ON duration, or the DL sensing signal may be received in a CDRX OFF duration and a sensing result corresponding to the DL sensing signal may be transmitted in a next CDRX ON duration.

In some implementations, the DL sensing signal may include an SSB, a TRS, or a dedicated DL sensing signal, the UL sensing signal may include an SRS or a dedicated UL sensing signal, and/or apparatus 1020 may include a BS, a CN node, or a UE.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus operating as a sensing node, a capability report to a sensing function (SF), wherein the capability report indicates that the apparatus supports a sensing operation;
receiving, by the processor, a sensing task configuration from the SF; and
performing, by the processor, the sensing operation based on the sensing task configuration, wherein the sensing operation comprises at least one of the following:
receiving a downlink (DL) sensing signal according to the sensing task configuration; and
transmitting an uplink (UL) sensing signal according to the sensing task configuration.

2. The method of claim 1, wherein the sensing operation further comprises performing sensing of a target object based on the DL sensing signal to generate a sensing result.

3. The method of claim 2, wherein the DL sensing signal is received in an idle mode or an inactive mode, and the sensing operation further comprises:
entering a connected mode to transmit the sensing result to the SF.

4. The method of claim 2, wherein the DL sensing signal is received in an inactive mode, and the sensing operation further comprises:
staying in the inactive mode to transmit the sensing result to the SF via a small data transmission (SDT).

5. The method of claim 1, wherein:
the UL sensing signal is transmitted in an idle mode or an inactive mode; or
the UL sensing signal is transmitted via a small data transmission (SDT) in the inactive mode.

6. The method of claim 1, further comprising:
performing, by the processor, a radio resource management (RRM), a synchronization, or a beam management (BM) based on the DL sensing signal.

7. The method of claim 1, further comprising:
receiving, by the processor, an indication from the SF in an idle mode; and
entering, by the processor, the idle mode, an inactive mode, or a connected mode to perform the sensing operation responsive to the indication.

8. The method of claim 1, wherein:
the DL sensing signal or the UL sensing signal is received or transmitted in a connected-mode discontinuous reception (CDRX) ON duration; or
the DL sensing signal is received in a CDRX OFF duration and a sensing result corresponding to the DL sensing signal is transmitted in a next CDRX ON duration.

9. The method of claim 1, wherein the DL sensing signal comprises a synchronization signal block (SSB), a tracking reference signal (TRS), or a dedicated DL sensing signal, and the UL sensing signal comprises a sounding reference signal (SRS) or a dedicated UL sensing signal.

10. The method of claim 1, wherein the SF comprises a base station (BS), a core network (CN) node, or a user equipment (UE).

11. A method, comprising:
receiving, by a processor of an apparatus operating as a sensing function (SF), a capability report from a sensing node, wherein the capability report indicates that the sensing node supports a sensing operation; and
transmitting, by the processor, a sensing task configuration to the sensing node to enable the sensing node to perform the sensing operation based on the sensing task configuration, wherein the sensing operation comprises at least one of the following:
receiving a downlink (DL) sensing signal according to the sensing task configuration; and
transmitting an uplink (UL) sensing signal according to the sensing task configuration.

12. The method of claim 11, wherein the sensing operation further comprises performing sensing of a target object based on the DL sensing signal to generate a sensing result.

13. The method of claim 12, wherein the DL sensing signal is received in an idle mode or an inactive mode, and the sensing operation further comprises:
entering a connected mode to transmit the sensing result to the SF.

14. The method of claim 12, wherein the DL sensing signal is received in an inactive mode, and the sensing operation further comprises:
staying in the inactive mode to transmit the sensing result to the SF via a small data transmission (SDT).

15. The method of claim 11, wherein:
the UL sensing signal is transmitted in an idle mode or an inactive mode; or
the UL sensing signal is transmitted via a small data transmission (SDT) in the inactive mode.

16. The method of claim 11, further comprising:
transmitting, by the processor, an indication to the sensing node, wherein the indication indicates the sensing node to perform a radio resource management (RRM), a synchronization, or a beam management (BM) based on the DL sensing signal.

17. The method of claim 11, further comprising:
transmitting, by the processor, an indication to the sensing node, wherein the indication triggers the sensing node to enter an idle mode, an inactive mode, or a connected mode to perform the sensing operation.

18. The method of claim 11, wherein:
the DL sensing signal or the UL sensing signal is received or transmitted in a connected-mode discontinuous reception (CDRX) ON duration; or
the DL sensing signal is received in a CDRX OFF duration and a sensing result corresponding to the DL sensing signal is transmitted in a next CDRX ON duration.

19. The method of claim 11, wherein:
the DL sensing signal comprises a synchronization signal block (SSB), a tracking reference signal (TRS), or a dedicated DL sensing signal;
the UL sensing signal comprises a sounding reference signal (SRS) or a dedicated UL sensing signal; or
the SF comprises a base station (BS), a core network (CN) node, or a user equipment (UE).

20. An apparatus, operating as a sensing node, comprising:
a transceiver which, during operation, wirelessly communicates with a sensing function (SF); and
a processor communicatively coupled to the transceiver such that, during operation, the processor performs operations comprising:
transmitting, via the transceiver, a capability report to the SF, wherein the capability report indicates that the apparatus supports a sensing operation;
receiving, via the transceiver, a sensing task configuration from the SF; and
performing the sensing operation based on the sensing task configuration, wherein the sensing operation comprises at least one of the following:
receiving, via the transceiver, a downlink (DL) sensing signal according to the sensing task configuration; and
transmitting, via the transceiver, an uplink (UL) sensing signal according to the sensing task configuration.
